(19) United States
(12) Patent Application Publication
(10) Pub. No.: US 2004/0191540 A1
(43) Pub. Date: Sep. 30, 2004

(54) Layered system and method for reducing a temperature realized by substrate and by an interior space

(76) Inventors: Michael Jakobi, Loerrach (DE); Martin Laudenbach, West Bloomfield, MI (US); Jon Hall, Oxford, MI (US)

Correspondence Address: BASF CORPORATION, ANNE GERRY SABOURIN, 26701 TELEGRAPH ROAD, SOUTHFIELD, MI, 48034-2442, US

(21) Appl. No.: 10/400,332

(22) Filed: Mar. 27, 2003

(51) Int. Cl. B32B 9/04

(52) U.S. Cl. 428/457; 283/91

(57) ABSTRACT

A layered system on a substrate reduces a temperature that is realized by the substrate. The layered system also reduces the temperature that is realized by an interior space that is defined by the substrate. The layered system includes a first layer that is applied onto the substrate. A second layer is applied onto the first layer. The second layer is darker than the first layer and includes a particular pigment. This pigment is transparent an infrared region such that infrared energy transmits through the second layer and is reflected away from the substrate by the first layer thereby reducing any effect that the infrared energy has on a temperature of the substrate and the interior space.

### FIELD OF THE INVENTION

The subject invention generally relates to a layered system and a method for reducing a temperature realized by a substrate and by an interior space defined by the substrate. More specifically, a second layer of the system and method of the subject invention is darker in color than the first layer and includes a pigment that is transparent in an infrared (IR) region. As such, any IR energy external to the substrate and the interior space transmits through the second layer and is reflected away from the substrate by the first layer.

### BACKGROUND OF THE INVENTION

In the various coatings industries, such as the automotive coatings industry and the building coatings industry, a substrate defines an interior space. More specifically, in the automotive coatings industry, the substrate is typically a panel of a vehicle, and the interior space is an interior passenger compartment defined by the vehicle panel. In the building coatings industry, the substrate is typically a panel of a commercial or residential building, such as a roof panel, and the interior space is an interior room of the building, such as an attic space, defined by the building panel.

It is known that IR energy external to the substrate and external to the interior space transmits onto the substrate and that the amount of this IR energy that is not reflected, or otherwise dissipated, is realized as heat, i.e., increased temperature, by the substrate and the interior space. This problem is particularly acute if the substrate is of a dark color including, but not limited to, black or dark blue, or if the substrate has a layer on it that is of the dark color.

Dark colors, such as black and dark blue, are commonly used in the automotive coatings industry to coat vehicles and to thereby provide an aesthetic appearance for the vehicle. Referring to the layered system of the prior art as disclosed in FIG. 1 (Prior Art), such dark colored vehicles are particularly susceptible to IR energy as these dark colors typically reflect insignificant amounts of IR energy. As a result, the vehicle panels of these vehicles, such as the roof, as well as the interior passenger compartment, realize increased temperatures and become very hot, especially on a sunny day. This is particularly uncomfortable for occupants of the vehicle, especially upon initial entry into the vehicle. Furthermore, more resources, gas, etc. are required to adequately condition the climate within the interior passenger compartment of vehicles having dark colors, as compared to vehicles having lighter colors with a higher degree of reflectivity, such as white and silver aluminum.

The above deficiencies are especially true for layered systems of the prior art that incorporate conventional carbon black pigment. The carbon black pigment, in particular, has extremely poor, i.e., low, reflectivity. In fact, the reflectivity of a particular layer that incorporates the carbon black pigment can be as low as 4-6%. As a result, the incident IR energy is not reflected and the substrate and the interior space realizes up to 96% of the IR energy which significantly increases the temperature of the substrate and the interior space.

One potential solution to the problems described above has been to develop layered systems that are increasingly IR reflective. In such systems, the IR energy is reflected directly from the layer. However, the range of colors that can be generated in such systems is very limited due to the properties inherent is most IR reflective pigments. The resultant colors are not bright, rich, or pure. In other words, most of the colors developed with IR reflective pigments are washed out.

Due to the deficiencies associated with substrates that are of a dark color, such as black or dark blue, or that include a layer of the dark color, it is desirable to provide a unique system and method that are able to reduce the temperature realized by such substrates and by interior spaces defined by the substrates, which maintaining integrity, i.e., brightness, richness, and purity, of the dark color.

### SUMMARY OF THE INVENTION AND ADVANTAGES

A layered system and a method for reducing a temperature realized by a substrate and by an interior space defined by the substrate are disclosed. The system includes a first layer and a second layer. The first layer is applied onto the substrate opposite the interior space, and the second layer is applied onto the first layer. The second layer is darker in color than the first layer. The second layer also includes a pigment that is transparent in an IR (IR) region. As such, IR energy external to the substrate and to the interior space transmits through the second layer and is reflected away from the substrate by the first layer, which is lighter in color, or more reflective of IR energy, than the second layer. The reflection of the IR energy reduces any effect that the IR energy has on a temperature of the substrate and the interior space. The method of the subject invention applies a first coating composition onto the substrate to form the first layer on the substrate. The method also applies a second coating composition onto the first layer to form the second layer on the first layer.

Accordingly, the layered system and method disclosed in the subject invention reduce the temperature realized by the substrate and by the interior space, even where individual layers within the layered system are of a dark color, such as black or dark blue. As a result, in the automotive coatings industry, one advantage attributed to the subject invention is that vehicles can utilize dark colors yet the vehicle panels, as well as the interior passenger compartment, can remain relatively cool, and therefore comfortable, even on sunny days. Similarly, in the building coatings industry, the subject invention reduces the heat realized by panels and by interior rooms within a building, especially roofs and attic spaces.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic representation of a layered system of the prior art with a second layer having a conventional carbon black pigment that reflects an insignificant amount of IR energy such that increased temperature is realized by a substrate and an interior space;

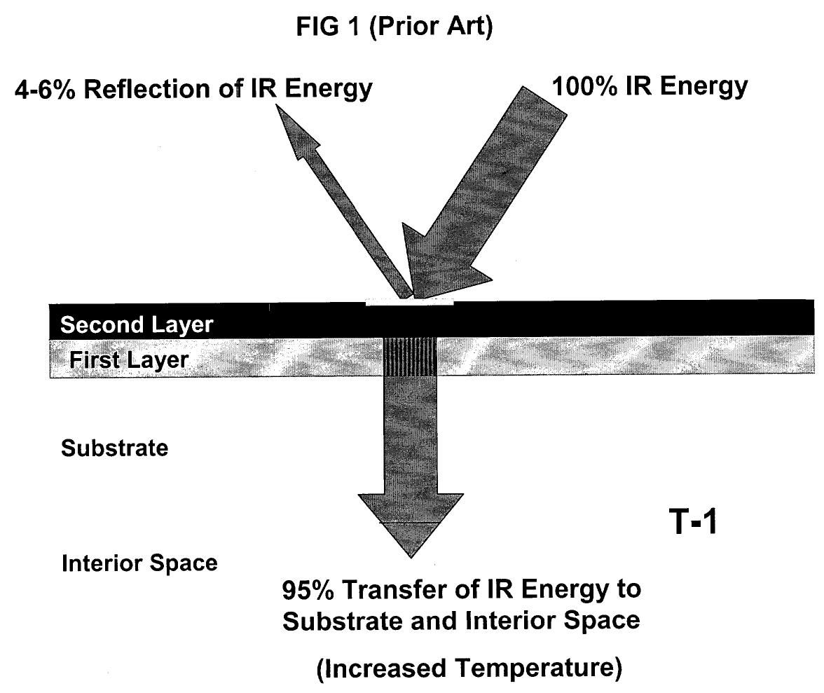

FIG. 2 is a schematic representation of a layered system of the subject invention having a substrate defining an interior space, a first layer and a second layer, wherein the second layer includes a pigment that is transparent to energy in an IR region such that reduced temperature is realized by the substrate and the interior space;

FIG. 3 is a schematic representation of the layered system of FIG. 2 having a third layer;

FIG. 4 is a schematic representation of the layered system of FIG. 3 wherein the third layer, the second layer, third layer, the substrate, and the interior space are more specifically disclosed as a clearcoat layer, a basecoat layer, a primer surfacer layer, a panel of a vehicle, and an interior passenger compartment of the vehicle, respectively;

FIG. 5 is a graph entitled “Temperature Comparison of the Interior Space”; and

FIG. 6 is a graph entitled “Temperature Comparison of the Interior Space”.

### DETAILED DESCRIPTION OF THE INVENTION

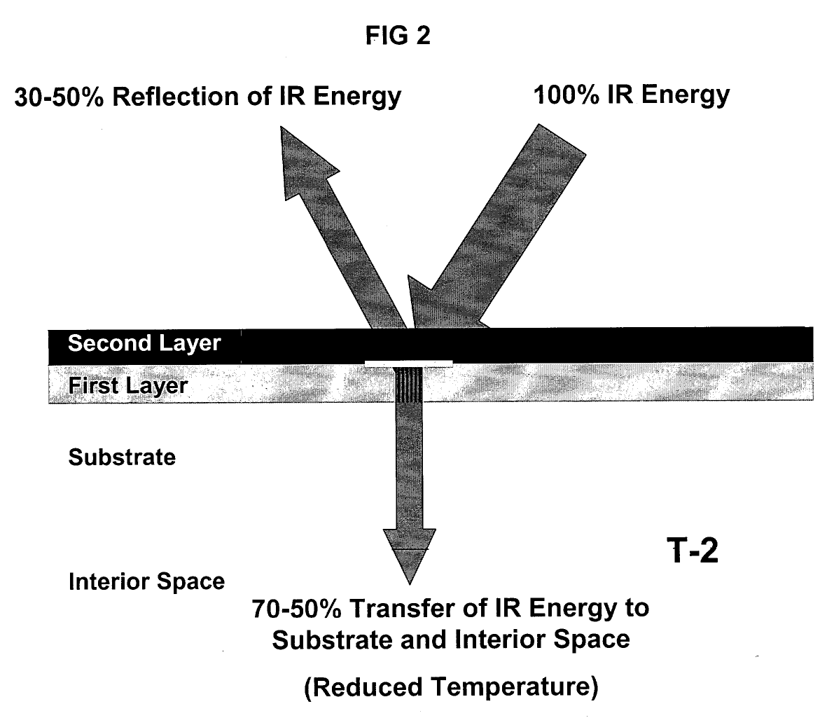

Referring to the Figures, wherein like numerals indicate like or corresponding parts throughout the several views, a layered system is generally disclosed. As disclosed in FIG. 2, the layered system according to the subject invention includes a substrate, a first layer, and a second layer. The substrate defines an interior space. Although the interior space may be entirely encompassed by the substrate, there is no requirement for the substrate to completely envelop the interior space. Instead, the interior space can be open. Generally, the interior space is defined on a side of the substrate that is away from a source of infrared (IR) energy, such as the sun.

The particular substrate utilized in the subject invention is not intended to vary the scope of the invention. Preferably, the substrate is metal, such as aluminum or steel, plastic, a panel of a vehicle, or a panel of a building, either a commercial or residential building, such as a roof. Most preferably, the substrate is a metal or plastic body panel of a vehicle. Alternative substrates include, but are not limited to, pavement surfaces, glass, and panels for vehicles such as airplanes and boats. If the substrate is the panel of the vehicle, then the interior space is an interior compartment of the vehicle, such as an interior passenger compartment, an interior trunk compartment, or under a hood of the vehicle. If the substrate is the panel of the building, then the interior space is an interior room of the building, such as an attic space.

Referring again to FIG. 2, the first layer is applied onto the substrate opposite the interior space, and the second layer is applied onto the first layer. It is to be understood that, within the context of the subject invention, the substrate may include additional treatment layers and the first layer is still considered to be “applied onto” the substrate. For example, if the substrate is the panel of the vehicle, then it is likely that the vehicle panel will also include a phosphate treatment layer and an electrocoat treatment layer on top of the phosphate treatment layer. Although in this example, the first layer is actually applied to the electrocoat layer, the first layer is still considered to be applied onto the substrate.

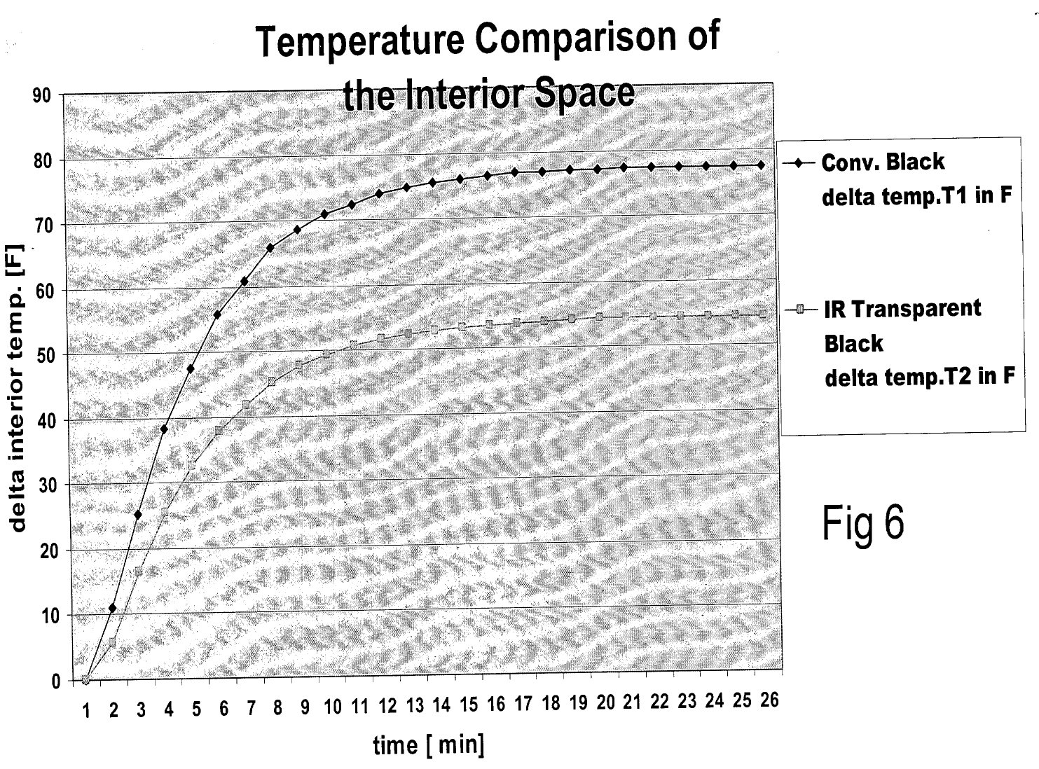

The second layer is darker in color than the first layer and includes a particular pigment. This pigment is transparent in an IR region such that the IR energy external to the substrate and external to the interior space transmits through the second layer. Once the IR energy transmits through the second layer, it is then reflected away from the substrate by the first layer, which is lighter in color than the second layer. It is to be understood that reference to the first layer being light in color than the second layer also includes first layers that are generally more reflective of IR energy than the second layer. As one example, the first layer may incorporate reflective beads to enhance the IR reflectivity of the first layer. For the purposes of the subject invention, the terminology “transparent” means to have the property of transmitting energy, e.g. light, without appreciable scattering. Reflection of the IR energy away from the substrate reduces any effect that the IR energy has on a temperature of the substrate and the interior space. The method of the subject invention reduces the temperature realized by the substrate and by the interior space defined by the substrate. The effect of the IR energy on the temperature is described additionally below with reference to FIG. 6.

For purposes of the subject invention and as would be appreciated by those skilled in the art, it is to be understood that the IR region, both near IR and far IR, is generally defined along the electromagnetic spectrum, between the visible, i.e., spectral, region and the microwave region at wavelengths of approximately 750 nm to 1 mm. As also appreciated by those skilled in the art, there is actually no precise division between the various regions along the electromagnetic spectrum.

The pigment incorporated into the second layer preferably has a % of Reflectance that increases at wavelengths of from 750 to 850 nm along the electromagnetic spectrum. More specifically, the pigment has a % of Reflectance that ranges from at least 10% at a wavelength of 750 nm along the electromagnetic spectrum to at least 90% at a wavelength of 900 nm. The % of Reflectance for the pigment is described additionally in the table below.

Preferably, the pigment included in the second layer is further defined as a perylene pigment, more preferably, a perylene pigment that is black. It is generally understood that a perylene-based pigment includes the organic structure:

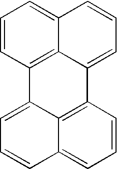

The most preferred pigment for use in the second layer of the subject invention is Paliogen® Black L0086, which is commercially available from BASF Corporation, Southfield, Mich. This particular pigment has a Colour Index of “Pigment Black 32” (Part 1) and “71133” (Part 2). Although not preferred, another pigment that is suitable for use in the second layer and that is commercially available from BASF Corporation is Paliogen® Black S0084, which has Colour Index of “Pigment Black 31” (Part 1) and “71132” (Part 2).

In this most preferred embodiment, where the pigment is the black perylene pigment, the black perylene pigment that is incorporated into the second layer preferably has a % of Reflectance that increases at wavelengths of from 750 to 850 nm along the electromagnetic spectrum. More specifically, the black perylene pigment has a % of Reflectance that ranges from at least 10% at a wavelength of 750 nm along the electromagnetic spectrum to at least 90% at a wavelength of 900 nm.

Further, it is contemplated that pigments other than the most preferred black perylene pigments can be incorporated into the second layer. It is only required that such other pigments are transparent in the IR region such that the IR energy can transmit through the darker second layer to the lighter first layer for subsequent reflectance. Such alternative pigments include, but are not limited to, various inorganic pigments commercially available from Ferro Corporation, Cleveland, Ohio, such as PC9415 a nickel-antimony-titanate yellow.

Although not required, it is preferred that the first layer is formed from a first coating composition. As such, the method of the subject invention applies the first coating composition onto the substrate to form the first layer on the substrate. In this preferred embodiment where the first layer is formed from the first coating composition, it is most preferred that the first coating composition is a primer surfacer coating composition that is applied onto the substrate to form a primer surfacer layer. As alluded to above, there is no requirement that the first layer actually be formed from a coating composition. Instead, for example, the first layer can be a thermoset or thermoplastic mat that is extruded from solid components. In this alternative example, the first layer can be adhered to the substrate.

The same holds true for the second layer. That is, although not required, it is preferred that the second layer is formed from a second coating composition. If the second layer is formed from the second coating composition, the second coating composition is preferably further defined as a basecoat coating composition and this basecoat coating composition is applied to the first layer, preferably the primer surfacer layer, to form a basecoat layer.

Whether the first layer is formed from a coating composition or not, the first layer has color values L*₁ and N₁. As is understood by those skilled in the art, the color value L*₁ is a value associated with and measured according to the CIELAB color-measuring system, and the color value N₁ is a value associated with and measured according to the Munsell color-measuring system. In the CIELAB color-measuring system, the L* value is associated with a central vertical axis that represents lightness and darkness, the lightest (white) being L*=100 and the darkest (black) being L*=0. In the Munsell color-measuring system, the N value is associated with the Munsell “value” which is defined as “the quality by which we distinguish a light color from a dark one.” Value is a neutral axis that refers to the grey level of the color and this neutral axis ranges from the lightest (white) being N=9/ to the darkest (black) being N=1/.

Similarly, the second layer has color values L*₂ and N₂. Because the second layer is described as darker in color than the first layer, i.e., the first layer is lighter in color than the second layer, the L*₁ is greater than L*₂ and N₁ is greater than N₂. More specifically, with respect to the CIELAB color-measuring system, for the first layer L*₁ ranges from 30 to 100 and for the second layer L*₂ ranges from 0 to 50, so long as L*₁ remains greater than L*₂. It is more preferred that for the first layer L*₁ ranges from 60 to 90 and for the second layer L*₂ ranges from 10 to 40, so long as L*₁ remains greater than L*₂. With respect to the Munsell color-measuring system, for the first layer N₁ ranges from 3/ to 9/ and for the second layer N₂ ranges from 1/ to 5/, so long as N₁ remains greater than N₂. It is more preferred that for the first layer N₁ ranges from 5/ to 9/ and for the second layer N₂ ranges from 1/ to 4/, so long as N₁ remains greater than N₂.

Where the first coating composition is the primer surfacer coating composition and the first layer is, therefore, the primer surfacer layer, both white and grey primer surfacers are preferred, especially light grey having an L*₁ of approximately 65 and an N₁ of approximately 6/ to 7/. In this situation, a black basecoat having an L*₂ of approximately 20 and an N₂ of approximately 2/ are preferred.

Due to the transparency of the pigment in the IR region and due to the higher reflectivity of the first layer as compared to the second layer (because the first layer is lighter than the second layer), the temperature of the interior space remains less than 60° F. as the layered system is subjected to IR energy for from 1 to 27 minutes. This temperature is described additionally below in the Examples with reference to FIG. 6.

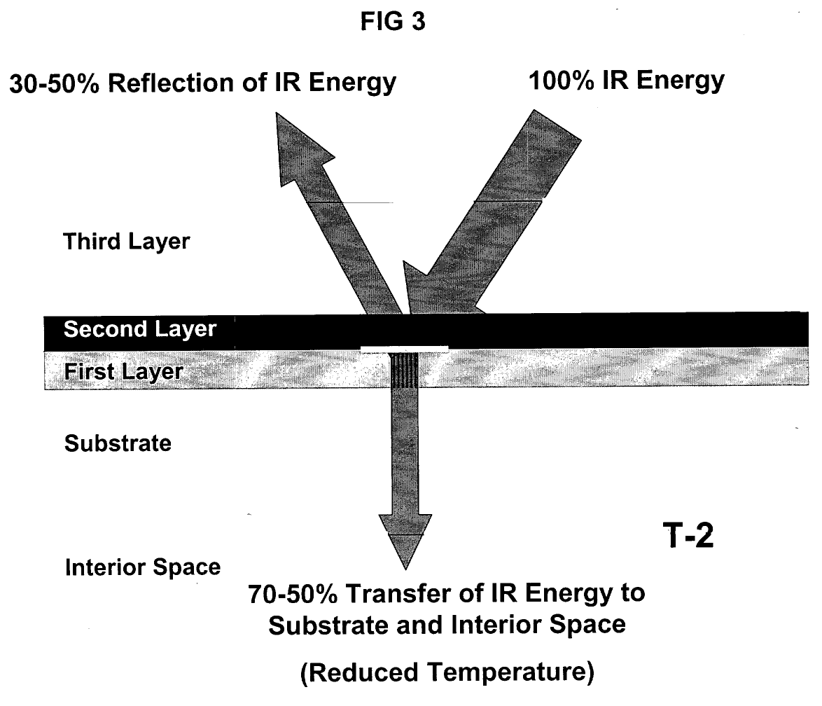

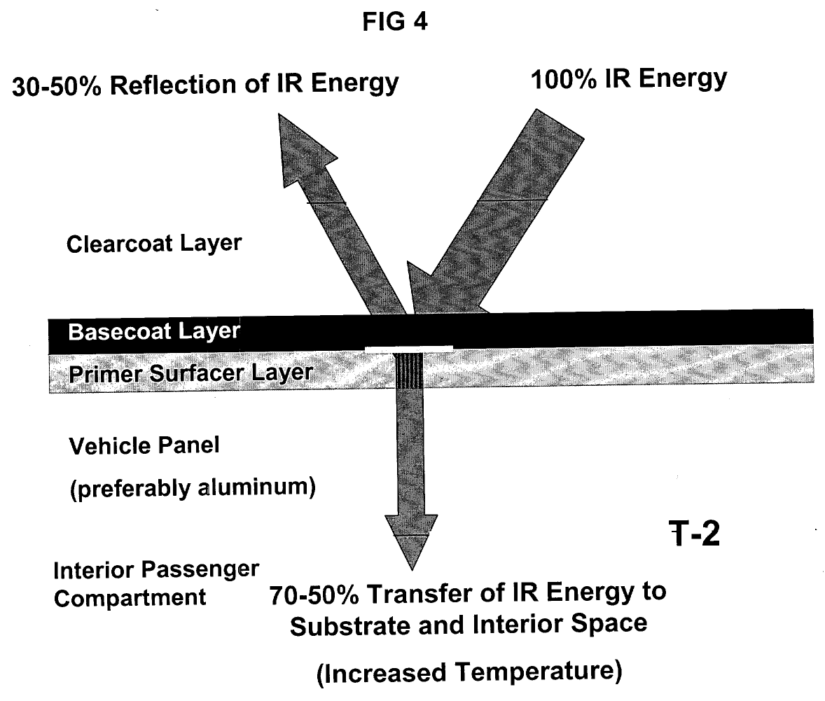

Referring to FIG. 3, the layered system may, optionally, further include a third layer applied onto the second layer. If so, the third layer is transparent in the IR region such that the IR energy external to the substrate and the interior space transmits through the third layer, to and through the second layer, and so on. It is also preferred that the third layer is formed from a third coating composition, most preferably a clearcoat coating composition. The clearcoat coating composition is applied onto the second layer, preferably the basecoat layer, to form a clearcoat layer. FIG. 4 discloses the layered system including the clearcoat layer as the third layer, the basecoat layer as the second layer, the primer surfacer layer as the first layer, the vehicle panel as the substrate, and the interior passenger compartment as the interior space defined by the vehicle panel.

If the first layer, second layer, and third layer, are formed from the first coating composition, the second coating composition, and the third coating composition, respectively, then all three of these coating compositions can be solventbome-based, waterbome-based, or powder-based. Furthermore, all three of these coating compositions can be based on any chemical technology including, but not limited to, acrylic/melamine and polyester/melamine. The chemical technologies for these coatings may also be based on carbonate chemistry, silane chemistry, carbamate chemistry, isocyanate chemistry, polyurethane chemistry, and so on. These chemical technologies can be OEM-oriented, where they most likely require a cure at elevated temperatures, or can be refinish-oriented where such a cure may not be required.

Preferably, the first, second, and third coating compositions are applied by spraying, either by the air- or rotary-atomized spray techniques. That is, preferably the first coating composition is sprayed onto the substrate to form the first layer, the second coating composition is sprayed onto the first layer to form the second layer, and the third coating composition is sprayed onto the second layer to form the third layer. However, it is to be understood that, if the first layer, the second layer, and the third layer, are formed by the first, second, and third coating compositions, respectively, then these coating compositions may be applied by other techniques including, but not limited to, dipping, rolling, and the like. Furthermore, persons skilled in the art recognize that these coatings may be applied “wet-on-wet” or “wet-on-wet-on-wet” with or without flash times between each layer. Persons skilled in the art will also recognize that the step of curing one layer before a subsequent coating composition is applied may also be preferred. For example, it is preferred that the first layer is cured prior to the step of applying the second coating composition. In the most preferred embodiment, this example is further defined as curing the primer surfacer layer prior to the step of applying the basecoat coating composition to form the basecoat layer.

On the other hand, if the first layer, second layer, and third layer, are not formed from the first, second, and third coating compositions, respectively, then these layers may be formed as laminates. For example, the first layer, second layer, and third layer may be extruded to form the laminate layers, so long as the second layer is extruded to include the pigment.

### EXAMPLES

The following examples illustrating the layered system formed from the first, second, and third coating compositions according to the subject invention, as presented herein, are intended to illustrate and not limit the invention.

For both Example 1 and Comparative Example 1, the first coating composition was applied to the substrate, a miniature car body, to form the first layer. The first coating composition is a convention coil coating primer surfacer composition that was applied at approximately 0.2 to 0.4 mils and has a color value L approximately equal to 60.

For both Example 1 and Comparative Example 1, the third coating composition was applied to the second layer, formed by the second coating compositions in the table below, to form the third layer. The third coating composition is a conventional clearcoat coating composition that was applied at approximately 1.8 to 2.0 mils. One such conventional clearcoat coating composition is commercially available from BASF Corporation, Southfield, Mich. as DC92 under their Diamont® product line. This clearcoat coating composition is a 2 component refinish composition based on isocyanate and urethane and may include a hardening agent.

The second coating compositions for Example 1 and Comparative Example 1, both black basecoat coating compositions, were prepared by adding, and then grinding in an Eiger mill, the following parts, by weight.

| Second Coating | | Comparative |
|---|---|---|
| Composition | Example | Example |
| Component | 1 | 1 |
| BC 100 Base | 90.00 | 90.00 |
| Pigment A | 10.00 | 0.00 |
| Pigment B | 0.00 | 10.00 |
| Total | 100.00 | 100.00 |
| ku | 72 | 74 |
| (pre-grind) | | |
| Eiger Mill Grind Time | ½ hr. | ½ hr. |
| Particle Size | <6 | <6 |
| (post-grind) | | |
| ku | 59 | 78 |
| (post-grind) | | |
| Rheomat | 133 | 1017 |
| 50 l/s | (cps) | (cps) |
| Rheomat | 106 | 356 |
| 900 l/s | (cps) | (cps) |

BC 100 Base is a solventbome, clear refinish base of polyester resin and cellulose acetate butyrate that is commercially available from BASF Corporation, Southfield, Mich. under their Diamont® product line;

Pigment A is a black, perylene pigment commercially available from BASF Corporation, Southfield, Mich. as Paliogen® Black L0086; and

Pigment B is a conventional, i.e., non IR transparent, carbon black pigment that is commercially available from such companies as the Degussa Corporation of New Jersey and the Cabot Corporation of Georgia.

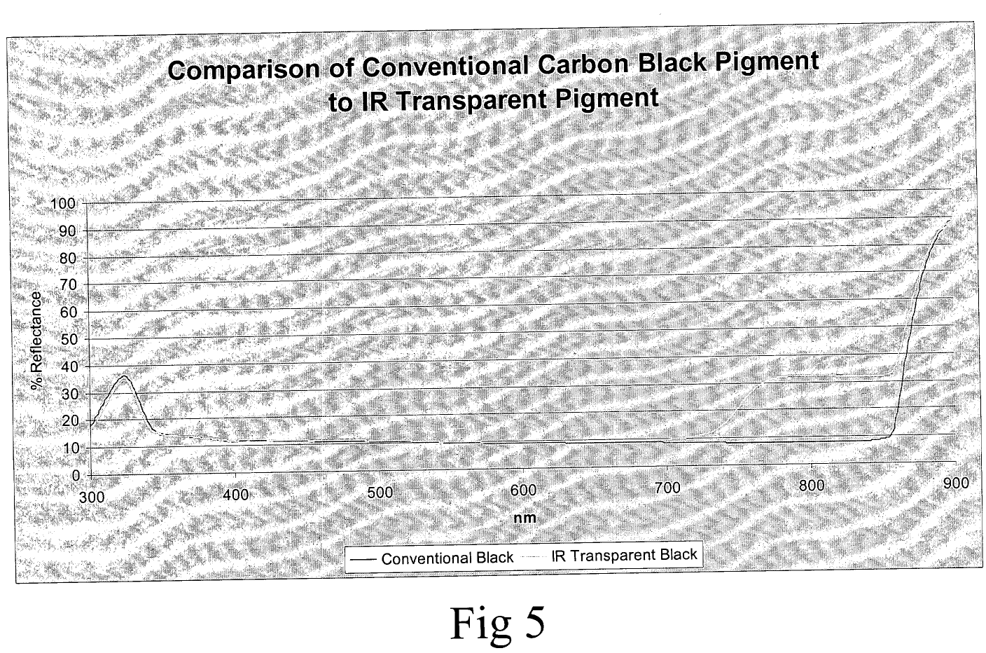

The % of Reflectance of Pigment A as compared to Pigment B, in the pertinent IR region, is summarized by the graph of FIG. 5. As the graph of FIG. 5, discloses, Pigment A, i.e., the IR transparent black perylene pigment utilized according to the subject invention, % of Reflectance that increases at wavelengths of from 750 to 850 nm in the IR region along the electromagnetic spectrum, whereas the convention black pigment, Pigment B of Comparative Example 1, does not possess a % of Reflectance that increases at wavelengths of from 750 to 850 nm in the IR region along the electromagnetic spectrum. Furthermore, Pigment A has a % of Reflectance that ranges from at least 10% at a wavelength of 750 nm along the electromagnetic spectrum to at least 90% at a wavelength of 900 nm, whereas the % of Reflectance of Pigment B of Comparative Example 1 does not begin to increase toward 90% until approximately 865 nm.

Once the Pigments A and B were ground in the Eiger mill for 1/2 hour, the blend of BC 100 Base and Pigment A and the blend of BC 100 Base and Pigment B were treated as basecoat coating compositions. For both Example 1 and Comparative Example 1, the second coating composition was applied to the first layer, specifically to the primer surfacer layer, to form the second layer, i.e., the basecoat layer, at approximately 0.5 to 0.6 mils.

For the spraying of the second and third coating compositions to form the second and third layers, respectively, standard solventbome refinish spray reductions were applied and the coating compositions were sprayed via an air-atomized spray technique with a siphon spray gun. After spraying, the miniature car body for Example 1 and the miniature car body for Comparative Example 1 were cured.

Referring now primarily to FIG. 6, after curing, the substrate, i.e., the miniature car bodies, were subjected to a test to determine the temperature differential of the interior space of the miniature car body of Example 1 as compared to the miniature car body of Comparative Example 1. In this test, a 250 Watt IR source lamp was disposed at a distance of approximately 22 cm from the miniature car bodies, which were positioned on a table. The car bodies were then subjected to this IR source for a period of approximately 30 minutes, and a temperature differential was determined. More specifically, to determine the temperature differential, one temperature probe was positioned on the surface of the miniature car bodies, i.e., on top of the substrate, the first layer, the second layer, and the third layer, and another temperature probe was positioned in the interior space between the substrate, i.e., the car body, and the table.

The graph of FIG. 6 discloses that the interior space of Example 1, which includes Pigment A, the IR transparent pigment, did not realize the increased temperatures that the interior space of Comparative Example 1, which includes the convention black pigment.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A layered system comprising:
a substrate defining an interior space;
a first layer applied onto said substrate opposite said interior space; and
a second layer applied onto said first layer, said second layer being darker in color than said first layer and comprising a pigment that is transparent in an infrared region such that infrared energy external to said substrate and said interior space transmits through said second layer and is reflected away from said substrate by said first layer, which is lighter in color than said second layer, for reducing any effect the infrared energy has on a temperature of said substrate and said interior space.

2. A layered system as set forth in claim 1 wherein said pigment is further defined as a perylene pigment.

3. A layered system as set forth in claim 2 wherein said perylene pigment is black.

4. A layered system as set forth in claim 3 wherein said black perylene pigment has a % of Reflectance that increases at wavelengths of from 750 to 850 nm along the electromagnetic spectrum.

5. A layered system as set forth in claim 3 wherein said black perylene pigment has a % of Reflectance that ranges from at least 10% at a wavelength of 750 mn along the electromagnetic spectrum to at least 90% at a wavelength of 900 nm.

6. A layered system as set forth in claim 1 wherein said pigment has a % of Reflectance that increases at wavelengths of from 750 to 850 nm along the electromagnetic spectrum.

7. A layered system as set forth in claim 1 wherein said pigment has a % of Reflectance that ranges from at least 10% at a wavelength of 750 nm along the electromagnetic spectrum to at least 90% at a wavelength of 900 nm.

8. A layered system as set forth in claim 1 wherein said first layer has a color value L*₁ and said second layer has a color value L*₂, as measured according to CIELAB color-measuring system, wherein L*₁ is greater than L*₂ because said second layer is darker in color than said first layer.

9. A layered system as set forth in claim 8 wherein L*₁ ranges from 30 to 100 and L*₂ ranges from 0 to 50, so long as L*₁ remains greater than L*₂.

10. A layered system as set forth in claim 1 wherein said first layer has a color value N₁ and said second layer has a color value N₂, as measured according to Munsell color-measuring system, wherein N₁ is greater than N₂ because said second layer is darker in color than said first layer.

11. A layered system as set forth in claim 10 wherein N₁ ranges from 3/ to 9/ and N₂ ranges from 1/ to 5/, so long as N₁ remains greater than N₂.

12. A layered system as set forth in claim 1 wherein said temperature of said interior space remains less than 60° F. as said layered system is subjected to infrared energy for from 1 to 27 minutes.

13. A layered system as set forth in claim 1 wherein said first layer is formed from a first coating composition and said second layer is formed from a second coating composition.

14. A layered system as set forth in claim 13 wherein said first coating composition is further defined as a primer surfacer coating composition and said second coating composition is further defined as basecoat coating composition.

15. A layered system as set forth in claim 14 further comprising a third layer applied onto said second layer, wherein said third layer is transparent in said infrared region and is formed from a third coating composition that is further defined as a clearcoat coating composition.

16. A layered system as set forth in claim 1 further comprising a third layer applied onto said second layer, wherein said third layer is transparent in said infrared region such that the infrared energy external to said substrate and said interior space transmits through said third layer.

17. A layered system as set forth in claim 16 wherein said third layer is formed from a third coating composition that is further defined as a clearcoat coating composition.

18. A layered system as set forth in claim 1 wherein said substrate is metal.

19. A layered system as set forth in claim 1 wherein said substrate is plastic.

20. A layered system as set forth in claim 1 wherein said substrate is a panel of a vehicle.

21. A layered system as set forth in claim 20 wherein said interior space is an interior passenger compartment of the said vehicle.

22. A layered system as set forth in claim 1 wherein said substrate is a panel of a building.

23. A method for reducing a temperature realized by a substrate and by an interior space defined by the substrate, said method comprising the steps of:
applying a first coating composition onto the substrate to form a first layer on the substrate; and
applying a second coating composition onto the first layer to form a second layer on the first layer, wherein the second layer is darker in color than the first layer and comprises a pigment that is transparent in an infrared region such that infrared energy external to the substrate and the interior space transmits through the second layer and is reflected away from the substrate by the first layer, which is lighter in color than the second layer, for reducing any effect the infrared energy has on the temperature of the substrate and the interior space.

24. A method as set forth in claim 23 wherein the step of applying the first coating composition is further defined as spraying the first coating composition onto the substrate to form the first layer, and the step of applying the second coating composition is further defined as spraying the second coating composition onto the first layer to form the second layer.

25. A method as set forth in claim 23 further comprising the step of curing the first layer prior to the step of applying the second coating composition.

26. A method as set forth in claim 23 further comprising the step of applying a third coating composition onto the second layer to form a third layer on the second layer that is transparent in the infrared region such that infrared energy external to the substrate and the interior space transmits through the third layer.

27. A method as set forth in claim 23 wherein the step of applying the first coating composition is further defined as applying a primer surfacer coating composition onto the substrate to form a primer surfacer layer on the substrate.

28. A method as set forth in claim 27 wherein the step of applying the second coating composition is further defined as applying a basecoat coating composition onto the primer surfacer layer to form a basecoat layer on the primer surfacer layer.

29. A method as set forth in claim 28 further comprising the step of applying a third coating composition onto the second layer to form a third layer on the second layer that is transparent in the infrared region such that infrared energy external to the substrate and the interior space transmits through the third layer.

30. A method as set forth in claim 29 wherein the step of applying the third coating composition is further defined as applying a clearcoat coating composition onto the basecoat layer to form a clearcoat layer on the basecoat layer.

31. A method as set forth in claim 23 wherein the substrate is metal and the step of applying the first coating composition is further defined as applying the first coating composition onto the metal to form the first layer on the metal.

32. A method as set forth in claim 23 wherein the substrate is plastic and the step of applying the first coating composition is further defined as applying the first coating composition onto the plastic to form the first layer on the plastic.

33. A method as set forth in claim 23 wherein the substrate is a panel of a vehicle and the step of applying the first coating composition is further defined as applying the first coating composition onto the panel of the vehicle to form the first layer on the panel.

34. A method as set forth in claim 23 wherein the substrate is a panel of a building and the step of applying the first coating composition is further defined as applying the first coating composition onto the panel of the building to form the first layer on the building.

35. A method as set forth in claim 23 wherein the pigment in the second layer is further defined as a perylene pigment.

36. A method as set forth in claim 35 wherein the perylene pigment is black.

37. A method as set forth in claim 23 wherein the pigment has a % of Reflectance that increases at wavelengths of from 750 to 850 nm along the electromagnetic spectrum.

38. A method as set forth in claim 23 wherein the first layer has a color value L*₁ and the second layer has a color value L*₂, as measured according to CIELAB color-measuring system, wherein L*₁ is greater than L*₂ because the second layer is darker in color than the first layer.

39. A method as set forth in claim 38 wherein L*₁ ranges from 30 to 100 and L*₂ ranges from 0 to 50, so long as L*₁ remains greater than L*₂.

40. A method as set forth in claim 23 wherein the first layer has a color value N₁ and the second layer has a color value N₂, as measured according to Munsell color-measuring system, wherein N₁ is greater than N₂ because the second layer is darker in color than the first layer.

41. A method as set forth in claim 40 wherein N₁ ranges from 3/ to 9/ and N₂ ranges from 1/ to 5/, so long as N₁ remains greater than N₂.

42. A layered system comprising:
a substrate defining an interior space;
a first layer applied onto said substrate opposite said interior space; and
a second layer applied onto said first layer, said second layer being darker in color than said first layer and comprising a perylene pigment that black and transparent in an infrared region such that infrared energy external to said substrate and said interior space transmits through said second layer and is reflected away from said substrate by said first layer, which is lighter in color than said second layer, for reducing any effect the infrared energy has on a temperature of said substrate and said interior space.

43. A layered system as set forth in claim 42 wherein said black perylene pigment has a % of Reflectance that increases at wavelengths of from 750 to 850 nm along the electromagnetic spectrum.

44. A layered system as set forth in claim 42 wherein said black perylene pigment has a % of Reflectance that ranges from at least 10% at a wavelength of 750 nm along the electromagnetic spectrum to at least 90% at a wavelength of 900 nm.

45. A layered system as set forth in claim 42 wherein said first layer has a color value L*₁ and said second layer has a color value L*₂, as measured according to CIELAB color-measuring system, wherein L*₁ is greater than L*₂ because said second layer is darker in color than said first layer.

46. A layered system comprising:
a substrate defining an interior space;
a first layer applied onto said substrate opposite said interior space and having a color value L*₁; and
a second layer applied onto said first layer, said second layer having a color value L*₂ that is less than L*₁ because said second layer is darker in color than said first layer, and said second layer comprising a pigment that is transparent in an infrared region such that infrared energy external to said substrate and said interior space transmits through said second layer and is reflected away from said substrate by said first layer, which is lighter in color than said second layer, for reducing any effect the infrared energy has on a temperature of said substrate and said interior space,
wherein L*₁ and L*₂ are measured according to CIELAB color-measuring system.

47. A layered system as set forth in claim 46 wherein said pigment is further defined as a perylene pigment.

48. A layered system as set forth in claim 47 wherein said perylene pigment is black.
